(19) United States
(12) Patent Application Publication
(10) Pub. No.: US 2024/0301165 A1
(43) Pub. Date: Sep. 12, 2024

(54) FLAME RETARDANT AND SMOKE SUPPRESSANT ADDITIVES FOR POLYMERS

(71) Applicant: Blue Fusion Products, LLC, Charlotte, NC (US)

(72) Inventors: Deen Chundury, Elkhorn, NE (US); Gary F. Dickison, II, Waxhaw, NC (US)

(73) Assignee: Blue Fusion Products, LLC, Charlotte, NC (US)

(21) Appl. No.: 18/596,746

(22) Filed: Mar. 6, 2024

Related U.S. Application Data
(60) Provisional application No. 63/450,132, filed on Mar. 6, 2023.

(51) Int. Cl. C08K 3/32; C08K 3/34; C08K 5/053; C08K 7/14; C08K 9/02; C08K 9/04; C08K 13/06; C08L 23/12

(52) U.S. Cl. CPC C08K 3/32; C08K 3/346; C08K 5/053; C08K 7/14; C08K 9/02; C08K 9/04; C08K 13/06; C08L 23/12; C08K 2003/323; C08K 2003/328; C08K 2201/003; C08L 2205/08

(57) ABSTRACT

A polymer resin is provided having a compatibilizing agent, an ammonium polyphosphate flame retardant, a non-drip agent and a glass fiber reinforcement is provided. The ammonium polyphosphate flame retardant includes at least one of a crystallized ammonium polyphosphate, an ammonium polyphosphate, a melamine coated ammonium polyphosphate, a fine/crystal blend of ammonium polyphosphate, and any combination thereof. The polymer resin may also include a smoke suppressant, wherein the smoke suppressant is any one of or any combination of zinc (IV) hydrogen phosphate, particles having a fire retardant core that includes an overcoat of selected flame retardant materials, and a nanohybrid having a core that includes any an organic/inorganic halogenated, non-halogenated, and/or organophosphorus flame retardant material the surface of the core modified with nanoparticles of any one of or any combination of a metal and a metal oxide. The polymer resin may also include an enhancement additive.

### CLAIM TO PRIORITY

This utility application is based on provisional application No. 63/450,132 filed Mar. 6, 2023, entitled “FLAME RETARDANT AND SMOKE SUPPRESSANT ADDITIVES FOR POLYMERS” the contents of which are expressly incorporated herein by reference.

### FIELD OF INVENTION

The present disclosure relates to flame retardant additives that are singly or collectively functional as a flame retardant, a flame retardant polymer composition whereby the polymer composition is primarily non-halogen and lighter weight in nature, and a method of reducing the flammability of a polymer. A smoke suppressant having naturally occurring materials that substantially suppresses the smoke evolving from the flame retardant polymer composition is also disclosed.

### BACKGROUND

Polymeric materials are predominantly comprised of organic materials, which leads to a major shortcoming of such polymeric materials—i.e., their ability to burn. The flammability of some polymers can even be higher than wood or other natural fibers. The calorific values for polymers such as polypropylene, polyethylene, polystyrene, polyamide, polymethylmethacrylate are on the order of 27000-46000 KJ/kg, where the calorific value for wood is about 19000 KJ/kg. In addition, the evolution of smoke and soot, formation of droplets (dripping characteristics) and emission of highly toxic products accompany the oxidative combustion of some polymer materials. Thus, the continued use of polymer materials makes it a necessity to develop flame-retarded materials to combat such flammability and smoke evolution when exposed to a spark, flame, or fire.

Flame-retarded polymeric materials may be formed by adding suitable types of flame retardant additives. Flame retardant additives may be mixed with the base polymer. Alternatively, or in addition to, flame retardant materials may be chemically bonded to the polymer. The flame-retarding influence of such additives is mainly controlled by the mechanisms by which these additives may synergistically interact with the base polymer to reduce the flammability of the base polymer.

A burning cycle for polymer materials typically follows the cycle of heat generation when exposed to fire conditions resulting in pyrolysis and/or degradation of the polymeric material causing the formation of combustible gases. The combustible gases that are formed may create a flame and smoke upon exposure to oxygen. By its nature, combustion is an exothermic process causing the generation of more heat resulting in more pyrolysis of the polymers which supplies more fuel to feed the fire. Thus, as soon as the material begins to burn, the flame reaction just accelerates and may become difficult to stop resulting in flash over.

The combustibility process sequence of polymers described above may be reduced in any one or combination of the following ways: (1) increasing the thermal stability of polymers, (2) increasing the amount of char that forms during burning to reduce the contact pyrolyzed polymer has with air, (3) decrease the diffusion of combustible gases that form to slow their arrival to the flame, (4) reduce the amount of heat generated as a result of burning, (5) insulate the polymer surface to reduce the transfer of heat form the fire to the polymer surface, and/or (6) include a flame retardant additive in the polymer whereby inert gases are formed upon burning to reduce or eliminate the exotherm preventing the further pyrolysis of the polymer. (1), (2), (3), and (5) are condensed phase processes that take place in the polymer, while (4) and (6) are gas-phase processes that control the extent of heat generation upon combustion of the polymer.

There have been fire retardant based paints developed and marketed for use as coatings on finished products. Flame Off Coatings (Raleigh, North Carolina) offers an intumescent fire barrier paint marketed under the trademark FLAMEOFF®. FLAMEOFF 100 has been explored for use as an additive in polymer resins to provide some fire retardancy to the finished polymer with limited success.

In order to improve the flame retardancy performance of polypropylene, in particular, a flame retardant additive component system may be added to the polypropylene. Brominated flame retardants have been commonly used in polypropylenes, but highly toxic brominated dibenzodioxines and dibenzofurans may be formed during burning of some of the currently used brominated flame retardants.

In addition to controlling the evolution and persistence of burning of a polymer upon exposure to a flame, it is also desirable to reduce, if not eliminate entirely, the toxic substances in the emissions. There remains a need in the art to use alternatives to non-bromine based flame retardant solutions in polymeric materials.

In addition to controlling the flame resistance of the polymeric material, it is also desirable that the polymeric composition maintains a reasonably good flow and its desired mechanical, physical, thermal, and appearance properties and could easily to adopt different commercially needed processes including injection molding, blow molding, roto-molding, profile extrusion, and the like. There remains a need in the art for both flame retardant and smoke suppressant types of compounds to be included in polymeric materials. In particular, there remains a need in the art for both flame retardant and smoke suppressant types of compounds to be included in propylene based polymeric materials.

### SUMMARY OF INVENTION

The present invention relates to flame retardant materials that can be included in polymer resins. The present invention also relates to smoke suppressant materials and, optionally, enhancement additives, charring agents, non-drip agents, stabilizers, colorants, and, importantly, unique modifiers including compatibility agents that can improve the activity of the flame retardant materials and smoke suppressant synergists in a finished polymer. Without intending to be bound by theory, the polymers produced from such resins offer improved flame retardant protection and/or smoke suppressing capability with acceptable performance properties. Certain exemplary polymeric compounds are further included in this disclosure.

An aspect of the invention provides a polymer resin composition comprising a compatibilizing agent having a concentration of 5 wt % to 85 wt %. In an embodiment of the invention, the polymer resin composition additionally comprises an ammonium polyphosphate based flame retardant having from about 50 wt % to about 70 wt % ammonium polyphosphate, from about 15 wt % to about 25 wt % melamine polyphosphate, and from about 15 to about 25 wt % pentaerythritol. In certain embodiments of the invention, the polymer resin composition comprises from about 10 wt % to about 40 wt % the ammonium polyphosphate based flame retardant.

Still further to this embodiment of the invention, the polymer resin composition may comprise a non-drip agent having a concentration of from about 0.01 wt % to about 0.5 wt %; and a glass fiber modifier having a concentration of from about 0.5 wt % to about 3 wt %.

According to an embodiment of the invention, the compatibilizing agent includes a maleated polymer compound. In the case of a polyolefin-based polymer resin, the compatibilizing agent comprises a maleated polyolefin compound.

In an embodiment of the invention, the ammonium polyphosphate flame retardant includes at least one of a crystallized ammonium polyphosphate, an ammonium polyphosphate, a melamine coated ammonium polyphosphate, a fine/crystal blend of ammonium polyphosphate, and any combination thereof. Further pursuant to this embodiment of the invention, the ammonium polyphosphate is characterized as having from about 25 wt % to about 35 wt % phosphorus and from about 10 wt % to about 20 wt % nitrogen. Still further pursuant to this embodiment of the invention, the melamine coated ammonium polyphosphate is characterized by having a concentration of from about 5 wt % to about 25 wt % melamine based upon the weight of the melamine coated ammonium polyphosphate. Even still further pursuant to this embodiment of the invention, the fine/crystal blend of ammonium polyphosphate is characterized as having from about 15 wt % to about 25 wt % phosphorus and from about 15 wt % to about 30 wt % nitrogen.

In an embodiment of the invention, the ammonium polyphosphate flame retardant comprises a blend having melamine and up to three other flame retardant additives, the up to three other flame retardant additives comprising any one of or any combination of ammonium polyphosphate, melamine polyphosphate, and pentaerythritol. Further pursuant to this embodiment of the invention, the melamine of the ammonium polyphosphate flame retardant has a concentration of from about 15 wt % to about 25 wt %. Still further pursuant to this embodiment of the invention, the up to three other flame retardant compounds of the ammonium polyphosphate flame retardant have a concentration of from about 15 wt % to about 25 wt %. In certain embodiments of the invention, the ammonium polyphosphate flame retardant blend has a particle diameter of from about 10 microns to about 12 microns.

In an embodiment of the invention, the polymer resin composition of the invention may additionally comprise a melamine polyphosphate having a concentration of from about 1 wt % to about 20 wt %. In another embodiment of the invention, the polymer resin composition may additionally comprise a char promoter having a concentration of from about 1 wt % to about 20 wt %. Further pursuant to this embodiment of the invention, the char promoter comprises a pentaerythritol.

In another aspect of the invention, the polymer resin composition includes a smoke suppressant, in preferred embodiments, in combination with the fire retardants disclosed herein. In an embodiment of the invention, the smoke suppressant may comprise a zinc (IV) hydrogen phosphate. In certain embodiments of the invention, the zinc (IV) hydrogen phosphate has a concentration of from about 0.5 wt % to about 5 wt %.

In another embodiment of the invention, the smoke suppressant may comprise a fire retardant core having an overcoat including one of or any combination of organic/inorganic halogenated, non-halogenated, and organophosphorus flame retardant materials. Further pursuant to this embodiment of the invention, the fire retardant core has a diameter of up to about 500 nm.

Still further pursuant to this embodiment of the invention, the fire retardant core comprises any one of or any combination of a metal and a metal hydrate of magnesium, calcium, aluminum, iron, zinc, barium, copper, and nickel. Yet still further pursuant to this embodiment of the invention, the organic/inorganic halogenated, non-halogenated, and organophosphorus flame retardant materials includes any one of or any combination of ammonium polyphosphate, aluminum trihydroxide, magnesium (di) hydroxide, melamine polyphosphate, zinc molybdate, calcium zinc molybdate, zinc oxide/phosphate complexes, zinc carbonates, zinc borates, antimony trioxides, tin oxides, iron oxides, zeolites, glass fibers, melamine, melamine cyanurate, melamine homologues, carbon-based materials (graphite/expandable graphite), graphene/graphene oxide, carbon nanotubes, gypsum, calcium carbonate, silicon dioxide, silicon carbide, aluminum silicates; chlorine or bromine, or iodine or fluorine bonded to carbon; and organophosphates, organophosphonates, organophosphintes, organophosphine oxides, and organophosphites.

In certain embodiments of the invention, the smoke suppressant comprises a stearic acid coated natural mineral. Further pursuant to this embodiment of the invention, the natural mineral may include SiO₂, AlO, FeO, Fe₂O₃, MgO, CaO, Na₂O, K₂O, TiO₂, MnO, Ph₂O₅, and any combination thereof.

In certain embodiments of the invention, the smoke suppressant has a concentration of from about 2 wt % to about 25 wt %.

In still another embodiment of the invention, the smoke suppressant may comprise a nanohybrid having a core that includes any one of or any combination of an organic/inorganic halogenated, non-halogenated, and/or organophosphorus flame retardant material the surface of the core modified with nanoparticles of any one of or any combination of a metal and a metal oxide. Further pursuant to this embodiment of the invention, the metal and a metal oxide of the nanoparticles at the surface are based upon any one of or any combination of magnesium, calcium, aluminum, iron, zinc, barium, copper, and nickel.

In another aspect of the invention, the polymer resin composition includes enhancement additives. In an embodiment of the invention, the enhancement additive has a concentration of from about 0.05 wt % to about 5 wt %. Further pursuant to this embodiment of the invention, the enhancement additive includes any one of or any combination of a nano-composite of clay; and nano-sized particles including any on of or any combination of ZnO, TiO₂, and a nitrogen and phosphorus based fire retardants.

Other aspects and embodiments will become apparent upon review of the following description taken in conjunction with the accompanying drawings. The invention, though, is pointed out with particularity by the included claims.

### BRIEF DESCRIPTION OF THE DRAWINGS

Having thus described the invention in general terms, reference will now be made to the accompanying drawings, which are not necessarily drawn to scale, and wherein:

FIG. 1 is a front view of a test apparatus that is used in the 94 UL plastics flammability test;

FIGS. 2A-2B show sequence-test images of a UL94 plastics flammability test for sample number 20;

FIG. 3 shows a sample image following a UL94 plastics flammability test for sample no. 21;

FIG. 4 illustrates a sample image following a UL94 plastics flammability test for sample no. 22;

FIG. 5A is a view of the vertical flame test that is performed on a bar sample;

FIG. 5B is a view of the vertical flame test that is performed on a plaque sample; and

FIGS. 6A-6C show sequence-test images of a “Max-Out” burn test performed on sample number 26.

### DETAILED DESCRIPTION OF THE INVENTION

The present invention now will be described more fully hereinafter with reference to the accompanying drawings, in which some, but not all embodiments of the inventions are shown. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

As used in the specification and in the appended claims, the singular forms “a”, “an”, and “the” include plural referents unless the context clearly indicates otherwise. For example, reference to “a flame retardant” may include a plurality of such flame retardants.

It will be understood that relative terms may be used herein to describe one element's relationship to another element as, for example, may be illustrated in the Figures. It will be understood that relative terms are intended to encompass different orientations of the elements in addition to the orientation of elements as illustrated in the Figures. It will be understood that such terms can be used to describe the relative positions of the element or elements of the invention and are not intended, unless the context clearly indicates otherwise, to be limiting.

Embodiments of the present invention are described herein with reference to various perspectives, including, for example, perspective views that are representations of idealized embodiments of the present invention. As a person having ordinary skill in the art would appreciate, variations from or modifications to the shapes as illustrated in the Figures or the described perspectives are to be expected in practicing the invention. Such variations and/or modifications can be the result of manufacturing techniques, design considerations, and the like, and such variations are intended to be included herein within the scope of the present invention and as further set forth in the claims that follow. The articles of the present invention and their respective components described or illustrated in the Figures are not intended to reflect a precise description or shape of the component of an article and are not intended to limit the scope of the present invention.

Although specific terms are employed herein, they are used in a generic and a descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

As used herein, “inflammable” with respect to a polymer resin or a finished polymer means substance or a material not capable of supporting combustion or being ignited.

As used herein, “flammable” with respect to a polymer resin or a finished polymer means substance or a material capable of being easily ignited followed by burning quickly. In a non-limiting example, petrol or polypropylene is an example of flammable material.

As used herein, “flammability” with respect to a polymer resin or a finished polymer means substance or a material having the ability to support combustion.

As used herein, “self-extinguishing” with respect to a polymer resin or a finished polymer means a substance or a material that burns in the presence of a flame or under an intense heat source but stops burning after a period of time when that source is removed.

As used herein, “flame resistant”, which may also be represented herein as “flame-resistant,” with respect to a polymer resin or a finished polymer means a substance or a material resistant to ignition by a flame source for a limited time. In a non-limiting example, wet wood is a flame-resistance material that does not support a flame or begin to burn until the wet wood dried.

As used herein, “flame retardant”, which may also be represented herein as “flame-retardant,” with respect to a polymer resin or a finished polymer means a substance or a material made or treated to resist burning for a certain period of time. Flame retardant substances or materials are not flame-proof or fire-proof. In a non-limiting example, flame retardant plastics and children's sleepwear are constructed to be flame-retardant.

As used herein, “flame-proof” or “fire-proof”, which may also be represented herein as “flameproof”, “flame proof,” “fireproof,” or “fire proof,” with respect to a polymer resin or a finished polymer means a substance or a material that is resistant to damage or burning when the substance or material comes in contact with a flame. In a non-limiting example, asbestos, is often touted as fire-proof. Asbestos has melting point of about 1600° F. (871° C.), which may be higher than the average temperature found in a typical house fire.

As used herein, a “polymer resin” means any one or any combination of (1) a homopolymer, (2) a heterophasic copolymer (3) one or more random copolymers including one or more kinds of other monomers, (4) one or more block copolymers each comprising a first polymer and a second polymer, and (5) optionally, blends of any antioxidant, stabilizer, flame retardant, smoke suppressant, and other additives as further disclosed herein. The quantities of each of the compounds and associated monomers, polymers and copolymers included in the polymer resin vary and are as provided in the specification of the polymer resin. A polymer resin itself may also comprise a combination of different polymer resins.

The heterophasic copolymer consists of (a) a homopolymer monomer-based matrix, wherein the homopolymer-based matrix consists of the monomer of the homopolymer and/or a copolymer consisting of at least 70 wt % of the homopolymer monomer units and at most 30 wt % of ethylene and/or α-olefin monomer units, based on the total weight of the homopolymer monomer-based matrix, wherein the homopolymer monomer-based matrix is present in an amount of 60 to 95 wt % based on the total heterophasic copolymer and (b) a dispersed ethylene-α-olefin copolymer, wherein the dispersed ethylene-α-olefin copolymer is present in an amount of 40 to 5 wt % based on the total heterophasic copolymer and wherein the sum of the total amount of homopolymer-based matrix and total amount of the dispersed ethylene-α-olefin copolymer in the heterophasic copolymer is 100 wt % with respect to the heterophasic propylene copolymer.

A polymer resin may be further reacted in some manner, either in a thermosetting process and/or a thermoplastic process to form a partially polymerized polymer resin or a finished polymer whereby the polymer resin becomes polymerized. Non-limiting types of polymers include homopolymers and non-homopolymers such as copolymers, terpolymers, tetrapolymers, and higher analogs of polymers. A nonlimiting example of the types of polymers used in polymer resins and polymers formed therefrom include olefin-containing, diene-containing, and butene-containing polymers and copolymers.

Other nonlimiting, more specific examples of polymers include linear and non-linear polymers such as polyethylene, polyvinyl chloride, polyisobutylene, polystyrene, polycaprolactam (nylon), polyisoprene, and the like; polyamides, polycarbonates, polyelectrolytes, polyesters, polyethers, (polyhydroxy) benzenes, polyimides, polymers containing sulfur (e.g., polysulfides, polyphenylene sulfides, and polysulfones), polyolefins, polymethylbenzene, polystyrene and styrene copolymers (including acrylonitrile butadiene styrene), acetal polymers, acrylic polymers, acrylonitrile polymers and copolymers, polyolefins containing halogens (e.g., polyvinyl chloride and polyvinylidene chloride), cellulose acetate, ethylene-vinyl acetate, polyacrylonitrile, fluoropolymers and fluoroplastics, ionomer polymers, polymers containing one or more ketone groups, polyketones, liquid crystal polymers, polyamide-imides, polyaryletherketones; polymers containing one or more olefinic double bonds (e.g., polybutadiene, polydicyclopentadiene), polyolefin copolymers, polyphenylene oxide, polyurethanes, thermoplastic elastomers, polycarbonates, silicone polymers alkyd resin, epoxy resin, unsaturated polyester, vinyl ester, urea-, melamine-, or phenol-formaldehyde resin.

In an embodiment of the invention, the polymer resin or any of the constituent components thereof may have a melt flow rate as measured by ASTM D 1238 condition L (230° C./2.16 kg) (hereinafter referred to as “MFR”) from about 0.25 g up to about 250 g/10 min, from about 1 g up to about 200 g/10 min, from about 1 g up to about 150 g/10 min, from about 2 g up to about 150 g/10 min, from about 2 g up to about 100 g/10 min, from about 3 g up to about 100 g/10 min, from about 3 g up to about 50 g/10 min, from about 5 g up to about 40 g/min, from about 10 g to about 150 g/10 min, from about 10 g to about 100 g/10 min, from about 10 g to about 50 g/min, from about 50 g to about 250 g/10 min, from about 100 g to about 200 g/10 min, from about 110 g to about 150 g/10 min, from about 25 g to about 60 g/10 min, from about 30 g to about 50 g/10 min, or about 40 g/10 min.

In an embodiment of the invention, the polymer resin or any of the constituent components thereof comprise a compatibilizing agent. A compatibilizing agent may have one of or any combination of a polyolefin that has been graft a maleic anhydride or any other maleated polypropylene In certain embodiments of the invention, the polymer resin comprises a compatibilizing agent having a concentration of from about 5 wt % to about 85 wt %, from about 5 wt % to about 75 wt %, from about 5 wt % to about 50 wt %, from about 5 wt % to about 40 wt %, from about 5 wt % to about 30 wt %, from about 5 wt % to about 25 wt %, from about 5 wt % to about 20 wt %, from about 5 wt % to about 15 wt %, from about 5 wt % to about 10 wt % or form about 0.5 wt % to about 1.5 wt %.

In a nonlimiting embodiment of the invention, a polypropylene-based polymer resin comprises a compatibilizing agent that includes a polyethylene grafted with a maleic anhydride. In another nonlimiting embodiment of the invention, a polypropylene-based polymer resin comprises a compatibilizing agent that includes a maleated polypropylene. The concentrations of the maleic anhydride-base polyolefins or maleated polyolefins are further provided herein as a compatibilizing agent.

In another embodiment of the invention, the compatibilizing agent may comprise any one of or a combination of styrene copolymers and polymer blends. The styrene copolymers may comprise any one of or combination of styrene maleic anhydride copolymers; impact modified styrene maleic anhydride copolymer; copolymers of aromatic monomers with maleic anhydride and their derivatives; o-, m-, or p-acetoxy-styrene-maleic anhydride copolymers; alpha-methyl styrene-maleic anhydride copolymers; partially hydrolyzed or esterified-maleic-anhydride copolymers; terpolymers such as styrene-acrylonitrile-maleic, anhydride, and styrene-maleic anhydride-butadiene copolymers and blends of polystyrene with a polyarylene oxide, e.g., polyphenylene oxide and an elastomer.

Without intending to be bound by theory, the compatibilizing agent adapts the polymer properties in the polymer resin to allow the polymer to be more compatible with the other compounds included in the polymer resin or partially polymerized polymer resin. In one exemplary embodiment of the invention, the polymer in the polymer resin may be somewhat resistant to including other compounds in the polymer resin. It is intended that the compatibilizing agent and its concentration are selected to overwhelming overcome such resistance of the polymer. In another non-limiting example, the polymer is non-polar in nature, but a compatibilizing agent works to provide polarity to the polymer.

As further described herein, a compatibilizing agent is used with the polymer resins in combination with the flame retardants, the smoke suppressants, and other additives of the invention as further described herein to ensure the compounds synergistically work in the finished polymer to effect the desired property whether that property includes flame retardancy, smoke suppressancy, char, anti-drip—individually or in combination with each other.

In an embodiment of the invention, the polymer resin comprises a homopolymer having a MFR in the range as further disclosed herein. In other embodiments of the invention, the polymer is a glass reinforced polymer. A glass reinforced polymer may comprise, for instance, glass fiber filaments dispersed and thereby embedded in the polymer resin. In an embodiment of the invention, the glass reinforced portion of the polymer includes up to about 0.1 wt %, up to about 0.2 wt %, up to about 0.5 wt %, up to about 1 wt %, up to about 2 wt %, up to about 3 wt %, up to about 4 wt %, up to about 5 wt %, up to about 8 wt %, up to about 10 wt %, up to about 12 wt %, up to about 15 wt %, up to about 20 wt %, up to about 25 wt %, up to about 30 wt %, up to about 40 wt %, or up to about 50 wt % of the polymerized resin.

In an embodiment of the invention, the polymer resin comprises one or more antioxidant and/or stabilizer additives. Antioxidant and stabilizer additives include compounds selected from categories that include, without intending to be limiting, chain-breaking or peroxide-decomposing antioxidants, ultraviolet screening agents, triplet quenchers and metal deactivators.

An antioxidant may be selected to inhibit oxidation of a substance. This typically includes the step of contacting the substance with an antioxidant polymer produced by the process having the step of derivatizing a homopolymer or a block, star, hyperbranched, random, gradient block, or alternate copolymer with one or more phenolic antioxidants, where the phenolic antioxidants can be attached to the homopolymer or the block, star, hyperbranched, random, gradient block, or alternate copolymer by an acetal, amine, carbamate, carbonate, ester, ether or thioether linkage.

In an embodiment of the invention, the antioxidant includes a phenolic antioxidant. In a preferred embodiment of the invention, the phenolic antioxidant comprises hindered phenols. In yet an even more preferred embodiment of the invention, the phenolic antioxidant having a high molecular weight whereby non-limiting examples of high molecular weight phenolic antioxidants include 1,1,3-tris (2-methyl-4-hydroxy-5-t-butylphenyl) butane, 1,3,5-trimethyl-2,4,6-tris (3,5-di-t-butyl-4-hydroxybenzyl) benzene, tetrakis-[methylene-3-(3′, 5′-di-1-butyl-4′-hydroxyphenyl) propionate], methane, bis [3,3′-bis-(4′-hydroxy-3′-1-butylphenyl) butyric acid] glycol ester, and 1,3,5-tris (3 ‘, 5’-di-t-Butyl-4′-hydroxybenzyl)-S-triazine-2,4,6-(1H, 3H, 5H) trione.

In an embodiment of the invention, the polymer resin comprises a high molecular weight, hindered phenol phenolic antioxidant having a concentration of from about 0.01 wt % to about 0.25 wt %, from about 0.02 wt % to about 0.2 wt %, from about 0.03 wt % to about 0.15 wt %, from about 0.04 wt % to about 0.1 wt %, or from about 0.05 wt % to about 0.06 wt %.

In another embodiment of the invention, the stabilizer comprises a phosphate ester. Further pursuant to this embodiment of the invention, the phosphate ester may include one or more of triphenyl phosphate, trimethyl phosphate, or triethyl phosphate. Still further pursuant to this embodiment of the invention, the stabilizer may comprise a hindered phenolic as further described above. In an embodiment of the invention, the polymer resin comprises a phosphate ester having a concentration of from about 0.01 wt % to about 0.25 wt %, from about 0.03 wt % to about 0.2 wt %, from about 0.05 wt % to about 0.15 wt %, from about 0.07 wt % to about 0.13 wt %, or from about 0.09 wt % to about 0.11 wt %

The stabilizer typically prevents settling of the desired polymerized resin produced during the reaction. In a non-limiting example, a block copolymer dispersion stabilizer can be selected from a variety of polymers containing at least two blocks where at least one of the blocks is soluble in the dispersion medium and at least another of the blocks is insoluble in the dispersion medium. Without intending to be bound by theory, the stabilizer acts to disperse polymer products that are formed in the presence of the stabilizer. Further pursuant to the explanation provided above, the insoluble second block provides an anchor segment for attachment to the obtained polymer compound, thus reducing the solubility of the polymerized product in the dispersion medium. The soluble first block of the dispersion stabilizer provides a sheath around the otherwise insoluble polymer and maintains the polymeric product as numerous small discrete particles rather than an agglomerated or highly coalesced mass.

In yet another embodiment of the invention, the polymer resin comprises a micronized polytetrafluoroethylene compound. Without intending to be bound by theory, the polytetrafluoroethylene compound has been known to possess certain antioxidant and stabilization properties for the polymer; however, the inventors have found that the polytetrafluorethylene compound also acts as a non-drip agent in the finished polymer.

In an embodiment of the invention, the polymer resin comprises a polytetrafluorethylene compound having a concentration of from about 0.01 wt % to about 0.25 wt %, from about 0.02 wt % to about 0.2 wt %, from about 0.03 wt % to about 0.15 wt %, from about 0.04 wt % to about 0.1 wt %, or from about 0.05 wt % to about 0.06 wt %. Further pursuant to this embodiment of the invention, it is preferred that the polytetrafluorethylene compound be in a micro powder form having a peak molecular weight (“MP”) of up to about 1,400, up to about 1,300, up to about 1,200, up to about 1,100, up to about 1,000, up to about 900 or up to about 800.

As used herein, a “flame retardant” refers to a any compound that inhibits, prevents or reduces the spread of fire in a polymer where the flame retardant is included. The use of “flame retardant”, “flame resistance”, “fire resistance” or “fire resistance”, as used herein, means that the polymer where the flame retardant is included exhibits a limiting oxygen index (“LOI”) of at least 27. “Flame resistance” and/or “fire resistance” are defined as flame resistance standard ASTM D6413-99 for fabric compositions, flame endurance test NF P 92-504 for flame resistant fibers and fabrics, and such similar standards. For example, fire resistance can also be tested by measuring the afterburn time according to a corresponding subject 94 UL test. In this test, the materials to be tested are classified as UL-94 V-0, UL-94 V-1 and UL-94 V-2 based on the results obtained with 10 specimens.

For example, UL-94 V-0 represents that the maximum combustion time after removal of the ignition flame does not exceed 10 seconds, and the total combustion time of five test pieces does not exceed 50 seconds. Furthermore, none of the specimens release a drip that ignites the dry cotton situated at the base of the sample being tested. UL-94 V-1 provides a maximum combustion time after elimination of the ignition flame does not exceed 30 seconds, the total combustion time of the five test pieces does not exceed 250 seconds, and one of the specimens release a drip that ignites the dry cotton. Finally, UL-94 V-2 provides a maximum combustion time after the ignition flame is eliminated does not exceed 30 seconds, the total burning time of five test pieces does not exceed 250 seconds, and the specimen can emit a drip that ignites the dry cotton.

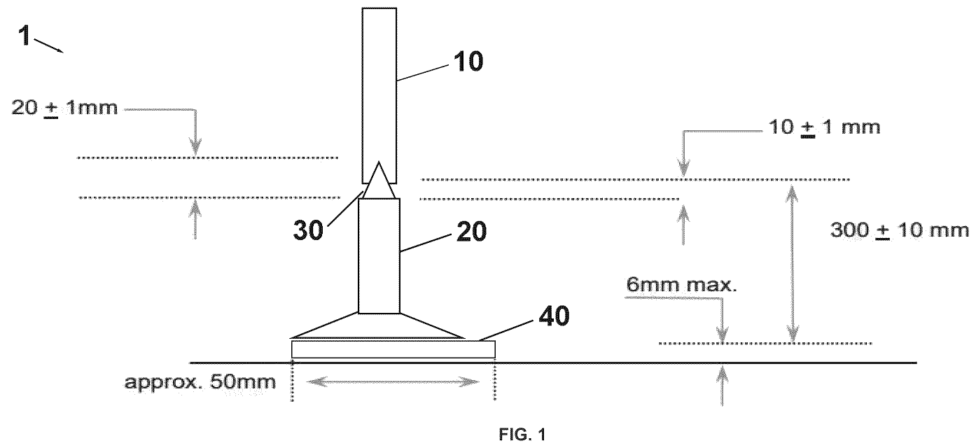

FIG. 1 includes a front view of a test apparatus that is used in the 94 UL plastics flammability test. The flammability test apparatus 1 includes a test specimen 10 having a length of 125 mm (5 in), a width of 13 mm (0.5 in), and a thickness of 0.7 mm ( 1/32 in) up to 3 mm (⅛ in). A burner 20 provides a flame 30 to contact the test specimen 10. The dry cotton 40 is at the base of the burner 20.

As used herein, a “smoke suppressant” refers to an additive in a polymer that results in smoke suppression for the polymer when exposed to fire as compared to the polymer being exposed to fire without the smoke suppressant. “Smoke suppressancy,” as used herein, means the extent of reduction in the generation of smoke when the polymer that includes the smoke suppressant becomes exposed to fire.

A “polymerized resin” also referred to herein as a “finished polymer” means a polymer resin that has at least partially become polymerized through it desired mode of processing to become the polymerized resin or finished polymer.

In some embodiments of the invention, the polymerized resin comprises an additive, a flame retardant, a smoke suppressant and the like in the “polymerized resin.” Further pursuant to this embodiment of the invention, the additive, the flame retardant, the smoke suppressant and the like are included when the polymer resin has become a partially polymerized resin. A “partially polymerized resin” means a mixed state of a polymer precursor and a monomer or other compounds making up the polymer resin.

An object of the invention is to provide a flame retardant and a smoke suppressant that synergistically provides a flame retardancy and a smoke suppressancy in a desired proportion and to a degree that exceeds the flame retardancy and the smoke suppressancy that would otherwise be experienced if the flame retardant or the smoke suppressant would individually be used alone in the finished polymer. In certain embodiments of the invention, the smoke suppressant may comprise an inorganic compound, an organic compound, and any combination thereof.

An aspect of the invention provides a flame retardant polymer resin having a flame retardant that is capable of providing the polymer formed therefrom, and any articles manufactured from a finished polymer with an acceptable flame resistance rating. The selection of the flame retardant used in connection with the polymer is such that it imparts a flame retardance to the polymer, especially in comparison to polymers without any flame retardants and over polymers having conventional flame retardants. In certain embodiments of the invention, the flame retardant polymer resin of the invention provides a finished polymer having at least a UL-94 V-0 fire retardant rating.

In an embodiment of the invention, the flame retardant comprises one or more phosphate-based compounds, in particular, a polyphosphate. Further pursuant to this embodiment of the invention, the polyphosphate compounds include ammonium polyphosphate. In an embodiment of the invention, the ammonium polyphosphate flame retardants of the invention are characterized as having particular phosphorus to nitrogen percentages. In certain embodiments of the invention, the ammonium polyphosphate flame retardants comprise a concentration of phosphorus that is from about from about 15 wt % to about 35 wt %, from about 18 wt % to about 32 wt %, from about 18 wt % to about 24 wt %, from about 18 wt % to about 21 wt %, from about 22 wt % to about 25 wt %, from about 23 wt % to about 24 wt %, from about 26 wt % to about 29 wt %, from about 27 wt % to about 28 wt %, from about 30 wt % to about 33 wt %, or from about 31 wt % to about 32 wt %. Further pursuant to these embodiments of the invention, the ammonium polyphosphate flame retardants comprise a concentration of nitrogen that is from about 10 wt % to about 30 wt %, from about 13 wt % to about 25 wt %, from about 13 wt % to about 16 wt %, from about 14 wt % to about 15 wt %, from about 20 wt % to about 24 wt %, or from about 21 wt % to about 23 wt %. In a preferred embodiment of the invention, the ammonium polyphosphate has a phosphorus concentration of about 17 wt % to 22 wt % or, more preferably about 18 wt % to about 21 wt % and a nitrogen concentration of about 20 wt % to about 24 wt % or, more preferably, from about 21 wt % to about 23 wt %. Further to this preferred embodiment of the invention, the ammonium polyphosphate is in the form of a fine crystal blend having a particle diameter of up to about 10 microns and up to about 12 microns according to other embodiments of the invention.

In certain embodiments of the invention, the ammonium polyphosphates of the invention additionally include melamine. Further pursuant to this embodiment of the invention, the melamine concentration in the ammonium polyphosphate-based flame retardant is from about 1 wt % to about 50 wt %, from about 5 wt % to about 40 wt %, from about 10 wt % to about 30 wt %, or from about 15 wt % to about 25 wt %. Further to this preferred embodiment of the invention, the ammonium polyphosphate is in the form of a fine crystal blend having a particle diameter of up to about 10 microns and up to about 12 microns according to other embodiments of the invention.

In an embodiment of the invention, the polymer resins comprising ammonium polyphosphate flame retardants additionally having melamine have a concentration of from about 5 wt % to about 75 wt, from about 10 wt % to about 70 wt %, from about 15 wt % to about 60 wt %, from about 20 wt % to about 50 wt %, from about 25 wt % to about 40 wt %, or from about 25 wt % to about 35 wt %.

St. Louis Group (Indianapolis, Indiana) offers ammonium polyphosphate compounds marketed under the trademarks PHOSGARD® APP and PHOSGARD® APP-311. Thor (Cheshire England) offers an ammonium polyphosphate compound marketed under the trademark AFLAMITT® PCI 202.

In certain embodiments of the invention, the flame retardant comprises a blend of ammonium polyphosphate, melamine, and a three-component blend comprising any of the flame retardant compounds as further disclosed herein. In an embodiment of the invention, the flame retardant blend includes from about 20 wt % to about 90 wt %, from about 30 wt % to about 80 wt %, from about 40 wt % to about 75 wt %, and, preferably, from about 50 wt % to about 70 wt % of ammonium polyphosphate. In certain embodiments of the invention, the flame retardant blend includes from about 2 wt % to about 50 wt %, from about 5 wt % to about 40 wt %, from about 10 wt % to about 30 wt %, and, preferably, from about 15 wt % to about 25 wt % of melamine. In still other embodiments of the invention, the flame retardant blend includes from about 2 wt % to about 50 wt %, from about 5 wt % to about 40 wt %, from about 10 wt % to about 30 wt %, and, preferably, from about 15 wt % to about 25 wt % of a three component blend of compounds that have flame retardant properties.

In an embodiment of the invention, the compounds imparting flame retardant properties to the polymer composition that may be used herein include, but are not limited to, tetrabromobisphenol A (TBBPA), tetrabromophthalate, bis (2, 3-dibromopropoxy) tetrabromobisphenol A, TBBPA-based brominated carbonate oligomers, TBBPA and epichlorohydrin-based condensation brominated epoxy oligomers, TBBPA and 1,2-dibromo copolymers of ethane; dibromobenzoic acid, dibromostyrene (DBS) and their derivatives; ethyl bromobistetrabromophthalimide, dibromoneopentadiol, dibromocyclooctyl Alkane, tribromoneopentyl alcohol, tris (tribromophenyl) triazine, 2,3-dibromopropanol, tribromoaniline, tribromophenol, tetrabromocyclopentane, tetrabromodiphenyl ether, tetrabromodi pentaerythritol, decabromodiphenyl ether, tetrabromophthalic anhydride, pentabromotoluene, pentabromodiphenyl ether, pentabromodiphenyl oxide, pentabromophenol, pentabromophenyl benzoate, pentabromoethylbenzene, Hexabromocyclohexane, hexabromocyclooctane, hexabromocyclodecane, hexabromocyclododecane, hexabromobenzene, hexabromobiphenyl, octabromobiphenyl, octabromodiphenyl oxide, poly (pentabromobenzyl acrylate), octabromodiphenyl ether, decabromodiphenylethane decabromodiphenyl, trimethylphenylindan, tetrabromochlorotoluene, bis (tetrabromophthalimide) ethane, bis (tribromophenoxy) ethane, brominated poly Styrene, brominated epoxy oligomer, pentabromobenzyl acrylate, dibromopropyl acrylate, dibromohexachlorocyclopentadiene cyclooctane, N′-ethyl (bis) dibromonorbornanedi varboximidine, tetrabromobisphenol S, N′N′-ethylbis (dibromonorbornene) dicarboximide, hexachlorocyclopentadiene bis (2,3-dibromo-1-propene)) Phthalates, phosphate bromides (e.g. bis (2,3-dibromopropyl) phosphate and tris (tribromoneopentyl) phosphate) and tris (dichlorobromopropyl) phosphate, N, N′-ethylbis (tetrabromophthalimide), tetrabromophthalic acid diol [2-hydroxypropyloxy-2-2-hydroxyethyl-ethyl tetrabromophthalate], vinyl bromide, pentabromobenzyl polyacrylate, polybromodibenzo-p-dioxine, tris (2,3-dibromopropyl) isocyanuric acid esters, diethyltetrabromophthalimide, tris (2,3-dibromopropyl) phosphate, one or more sterically hindered alkoxyamine stabilizers selected from the group consisting of: 1-cyclohexyloxy-2,2,6,6-tetramethyl-4-octadecylaminopiperidine; 2,4-bis [(1-cyclohexyloxy-2,2,6,6-tetramethylpiperidin-4-yl) butylamine Group]-6-(2-hydroxyethylamino-s-triazinc); adipic acid bis (1-cyclohexyloxy-2,2,6,6-tetramethylpiperidin-4-yl) Esters; 2,4-bis [(1-cyclohexyloxy-2,2,6,6-piperidin-4-yl) butylamino]-6-chloro-s-triazine; 1-(2-Hydroxy-2-methylpropoxy)-4-hydroxy-2,2,6,6-tetramethylpiperidine; 1-(2-hydroxy-2-methylpropoxy)-4-side oxygen-2,2,6,6-tetramethylpiperidine; 1-(2-hydroxy-2-methylpropoxy)-4-octadecyloxy-2,2,6,6-tetramethyl Methylpiperidine; sebacic acid bis (1-(2-hydroxy-2-methylpropoxy)-2,2,6,6-tetramethylpiperidin-4-yl) ester; adipic acid bis (1-(2-hydroxy-2-methylpropoxy)-2,2,6,6-tetramethylpiperidin-4-yl) ester; 2,4-bis {N-[1-(2-Hydroxy-2-methylpropoxy)-2,2,6,6-tetramethylpiperidin-4-yl]-N-butylamino}-6-(2-hydroxyethylamino)-s-triazine; 2,4-bis [(1-cyclohexyloxy-2,2,6,6-piperidin-4-yl) butylamine]-6-chloro-s-triazine with N, N′-bis (3-aminopropyl) ethylenediamine) and the reaction product of where n is 1 to 15. The flame retardant compounds may additionally include flame retardants selected from the group consisting of chloroalkyl phosphate, bis (hexachlorocyclopentadiene) cyclooctane, chlorinated paraffin, tetraphenylresorcinol diphosphite, triphenyl phosphate, ammonium polyphosphate, resorcinol diphosphate oligomer, melamine cyanurate, melamine borate, melamine polyphosphate, melamine phosphate, melamine pyrophosphate, ethylenediamine diphosphate, a phenolic antioxidant, calcium stearate, zinc stearate, phosphite or phosphonite stabilizer, benzofuranone stabilizer, 2-(2′-hydroxyphenyl) benzotriazole, 2-(2-hydroxyphenyl)-1,3,5-triazine or benzoate UV absorption agent, sterically hindered amine light stabilizer, bismuth oxychloride, bismuth oxyfluoride, bismuth bromide, iodine oxide, and bismuth oxynitrate, one or more organic bromine flame retardants, zinc oxide, zinc borate, antimony oxide, aluminum hydroxide, magnesium hydroxide, aluminum trihydrate, oxide aluminum hydrate, aluminum oxide trihydrate, magnesium oxide, magnesium chloride, talc, aluminum oxide-magnesium, calcium silicate, sodium silicate, zeolite, sodium carbonate, calcium carbonate, ammonium molybdate, iron oxide, copper oxide, zinc phosphate, zinc chloride, clay, sodium dihydrogen phosphate, tin, vanadium compounds, molybdenum, zinc zinc oxide, one or more bismuth compounds selected from the group consisting of bismuth oxychloride, bismuth oxyfluoride, bismuth bromide, iodine iodide, and bismuth oxynitrate and one or more organic bromine flame retardants.

In an embodiment of the invention, the polymer resin, or in the case of a partially polymerized polymer resin, comprises an ammonium polyphosphate in a concentration of from about 5 wt % to about 50 wt %, from about 10 wt % to about 40 wt %, from about 15 wt % to about 35 wt %, from about 15 wt % to about 20 wt %, from about 16 wt % to about 20 wt %, from about 18 wt % to about 20 wt %, from about 25 wt % to about 40 wt %, from about 25 wt % to about 35 wt %, or about 30 wt %.

According to an embodiment of the invention, the ammonium polyphosphate may be in the form of any one or combination of crystallized, a fine crystal blend, a powder form up to about 12 microns in diameter, a powder form up to about 10 microns in diameter, a powder from up to about 5 microns in diameter, and a powder form up to about 4 microns in diameter.

In certain embodiments of the invention, the flame retardant comprises melamine in combination with an ammonium polyphosphate. In one embodiment of the invention, an ammonium polyphosphate is coated with a melamine. Further pursuant to this embodiment of the invention, the melamine concentration is from about 2 wt % to about 20 wt % or from about 5 wt % to about 15 wt %. Even further pursuant to this embodiment of the invention, the ammonium polyphosphate has a phosphorus concentration of from about 25 wt % to about 30 wt % or from about 27 wt % to about 28 wt % and a nitrogen concentration of from about 15 wt % to about 20 wt % or from about 17 wt % to about 18 wt %.

In an embodiment of the invention, the polymer resin, or in the case of a partially polymerized polymer resin, comprises an ammonium polyphosphate coated with melamine in a concentration of from about 2 wt % to about 30 wt %, from about 5 wt % to about 25 wt %, from about 10 wt % to about 20 wt %, from about 15 wt % to about 20 wt %, from about 16 wt % to about 20 wt %, from about 17 wt % to about 19 wt %, or about 18 wt %.

St. Louis Group (Indianapolis, Indiana) offers an ammonium polyphosphate coated with melamine marketed under the trademark PHOSGARD® APP-MC.

In one embodiment of the invention, the flame retardant comprises a melamine polyphosphate. In certain embodiments of the invention, the melamine polyphosphate has a concentration of from about 10 wt % to about 20 wt %, from about 11 wt % to about 15 wt %, or from about 12 wt % to about 14 wt %, and the melamine polyphosphate has a nitrogen concentration of from about 40 wt % to about 50 wt %, from about 41 wt % to about 46 wt %, or from about 42 wt % to about 45 wt %. In certain embodiments of the invention, the melamine polyphosphate is in particle form having a particle diameter of up to about 12 microns, to about 10 microns, up to about 7 microns, up to about 5 microns, or up to about 4 microns.

In an embodiment of the invention, the polymer resin, or in the case of a partially polymerized polymer resin, comprises an melamine polyphosphate in a concentration of from about 2 wt % to about 25 wt %, from about 4 wt % to about 20 wt %, from about 5 wt % to about 15 wt %, from about 5 wt % to about 10 wt %, from about 5 wt % to about 7 wt %, or about 6 wt %. St. Louis Group (Indianapolis, Indiana) offers a melamine polyphosphate marketed under the trademark PHOSGARD® MPP-Poly.

In an embodiment of the invention, the flame retardant comprises a pentaerythritol. Without intending to be bound by theory, the pentaerythritol may also assist with the formation of char otherwise characterized herein as a “char promoter” or “char agent.” In an embodiment of the invention, the pentaerythritol is in particle form having a particle diameter of from 5 microns to 15 microns, from about 8 microns to about 12 microns, or from about 10 microns to about 12 microns. In an embodiment of the invention, the polymer resin, or in the case of a partially polymerized polymer resin, comprises pentaerythritol in a concentration of from about 2 wt % to about 25 wt %, from about 4 wt % to about 20 wt %, from about 5 wt % to about 15 wt %, from about 5 wt % to about 10 wt %, from about 5 wt % to about 7 wt %, or about 6 wt %.

In certain embodiments of the invention, the pentaerythritol flame retardant may additionally comprise dipentaerythritol. Further pursuant to this embodiment of the invention, the concentration of dipentaerythritol in the pentaerythritol flame retard is up to about 20 wt %, up to about 15 wt %, up to about 10 wt %, up to about 5 wt %, up to about 2 wt %, or up to about 1 wt %.

St. Louis Group (Indianapolis, Indiana) offers a pentaerythritol marketed under the trademark CHARFLAM® 100-P.

In yet other embodiments of the invention, the flame retardant may comprise other polyphosphate compounds. In an embodiment of the invention, the flame retardant may comprise piperazine polyphosphate. In an embodiment of the invention, the polymer resin, or in the case of a partially polymerized polymer resin, comprises piperazine polyphosphate in a concentration of from about 0.1 wt % to about 35 wt %, from about 1 wt % to about 30 wt %, from about 2 wt % to about 25 wt %, from about 5 wt % to about 20 wt %, from about 5 wt % to about 10 wt %, or from about 6 wt % to about 8 wt %.

In other embodiments of the invention, in addition to the compounds disclosed above, the flame retardant may comprise other phosphate or bisphosphonate groups. In an embodiment of the invention, the flame retardant may comprise any one or any combination of melamine phosphate, piperazine phosphate, 2-methylpiperazine monophosphate, tricresyl phosphate, alkyl phosphates, haloalkyl phosphates, poly(2-hydroxy propylene spirocyclic pentaerythritol bisphosphate) and poly(2,2-dimethylpropylene spirocyclic pentaerythritol bisphosphonate). In an embodiment of the invention, the polymer resin, or in the case of a partially polymerized polymer resin, comprises any one or any combination of melamine pyrophosphate, piperazine pyrophosphate, and tetraphenyl pyrophosphate in a concentration of from about 0.1 wt % to about 35 wt %, from about 1 wt % to about 30 wt %, from about 2 wt % to about 25 wt %, from about 5 wt % to about 20 wt %, from about 5 wt % to about 10 wt %, or from about 6 wt % to about 8 wt %. in a concentration of from about 0.1 wt % to about 35 wt %, from about 1 wt % to about 30 wt %, from about 2 wt % to about 25 wt %, from about 5 wt % to about 20 wt %, from about 5 wt % to about 10 wt %, or from about 6 wt % to about 8 wt %.

In still other embodiments of the invention, the flame retardant may comprise a pyrophosphate compound. In an embodiment of the invention, the flame retardant may comprise any one or any combination of melamine pyrophosphate, piperazine pyrophosphate, and tetraphenyl pyrophosphate. In an embodiment of the invention, the polymer resin, or in the case of a partially polymerized polymer resin, comprises any one or any combination of melamine pyrophosphate, piperazine pyrophosphate, and tetraphenyl pyrophosphate in a concentration of from about 0.1 wt % to about 35 wt %, from about 1 wt % to about 30 wt %, from about 2 wt % to about 25 wt %, from about 5 wt % to about 20 wt %, from about 5 wt % to about 10 wt %, or from about 6 wt % to about 8 wt %.

In yet other embodiments of the invention, the flame retardant may comprise an aromatic phosphate ester. In an embodiment of the invention, the polymer resin, or in the case of a partially polymerized polymer resin, comprises aromatic phosphate ester in a concentration of from about 0.1 wt % to about 15 wt %, from about 1 wt % to about 12 wt %, from about 2 wt % to about 10 wt %, from about 5 wt % to about 10 wt %, from about 6 wt % to about 9 wt %, or from about 6 wt % to about 7 wt %.

Another aspect of the invention provides a smoke suppressant polymer resin having a smoke suppressant that is capable of providing the polymer formed therefrom, and any articles manufactured from a finished polymer, with an acceptable smoke suppressant rating. The design and selection of the smoke suppressant used in connection with the polymer is such that the smoke suppressant acts to suppress the smoke evolving from a polymer subject to heat and/or flames. As used herein, this disclosure indicates that a smoke suppressant imparts a smoke “suppressance” to the polymer, especially when compared to similarly situated polymers that have no smoke suppressants and similarly situated polymers having conventional smoke suppressants.

According to an embodiment of the invention, the smoke suppressant comprises a zirconium (IV) hydrogen phosphate. Sunshine Factory (Mianzhu City, Deyang City, Sichuan Province, China) offers a zirconium (IV) hydrogen phosphate marketed under the name zirconium hydrogen phosphate (α-ZrP). In certain embodiments of the invention, the polymer resin, or in the case of a partially polymerized polymer resin, comprises a zirconium (IV) hydrogen phosphate having a concentration of from about 0.1 wt % to about 10 wt %, from about 0.5 wt % to about 5 wt %, from about 1 wt % to about 4 wt %, or from about 1.5 wt % to about 2.5 wt %.

In another embodiment of the invention, the smoke suppressant comprises a molybdate compound. The molybdate compounds include, but are not limited to zinc molybdate, calcium zinc molybdate and zinc oxide/phosphate complexes. Further pursuant to this embodiment of the invention, the molybdate compounds may be deposited onto the surface of an inert core particles. Such inert core particles include, but are not limited to magnesium hydroxide, calcium carbonate, talc and zinc oxide. Another molybdate compound, though less preferred over these active phase molybdate compounds already disclosed, include bulk molybdate compounds bulk molybdate compounds such as ammonium octamolybdate in a non-limiting example. In an embodiment of the invention, the polymer resin, or in the case of a partially polymerized polymer resin, comprises a molybdate compounds, more preferably, an active molybdate compound that is deposited onto the surface of an inert core particle having a concentration of from about 0.5 wt % to about 15 wt %, from about 1 wt % to about 10 wt %, from about 3 wt % to about 7 wt %, from about 4 wt % to about 6 wt %, or about 5 wt %.

In certain embodiments of the invention, the smoke suppressant may additionally function as a flame retardant. A smoke suppressant that may additionally function as a flame retardant comprises particles including a fire retardant core having a particle size of on the order of 1500 nm, from about 0.1 nm to about 1000 nm, from about 0.5 nm to about 750 nm, or from about 1 nm to about 500 nm, or from about 5 nm to about 100 nm. The fire retardant core comprises a metal, optionally in combination with a metal hydrate (Mg, Ca, Al, Fe, Zn, Ba, Cu, and Ni). The core is uniformly overcoated with any one or combination of organic/inorganic halogenated, non-halogenated, and organophosphorus flame retardant materials. In some embodiments of the invention, the core is uniformly overcoated with a polysilicon.

In an embodiment of the invention, the polymer resin, or in the case of a partially polymerized polymer resin, comprises a fire retardant core that is somewhat uniformly overcoated with any one or combination of organic/inorganic halogenated, non-halogenated, and organophosphorus flame retardant materials having a concentration of from about 1 wt % to about 40 wt %, from about 2 wt % to about 30 wt %, from about 2 wt % to about 25 wt %, from about 5 wt % to about 20 wt %, or from about 10 wt % to about 20 wt %.

In another embodiment of the invention, the smoke suppressant comprises a stearic acid coated natural mineral. In certain embodiments of the invention, the polymer resin, or in the case of a partially polymerized polymer resin, comprises a stearic acid coated natural mineral having a concentration of from about from about 1 wt % to about 40 wt %, from about 5 wt % to about 35 wt %, from about 10 wt % to about 30 wt %, or from about 20 wt % to about 30 wt %. Manascer (Ammon, Jordan) offers a stearic acid coated natural mineral marketed under the trade names MICSmart™ RT8 and MICSmart™ RT10.

In certain embodiments of the invention, the natural mineral may comprise any one of or any combination of silicon dioxide (SiO₂), aluminum oxide (AlO), iron oxide (FeO or Fe₂O₃), magnesium oxide (MgO), calcium oxide (CaO), sodium oxide (Na₂O), potassium oxide (K₂O), titanium dioxide (TiO₂), Manganese Oxide (MnO), and phosphorus pentoxide (Ph₂O₅). In an embodiment of the invention, the natural mineral may comprise less than about 80 wt % of SiO₂, from 5 wt % to about 40 wt % AlO, from about 1 wt % to about 40 wt % FcO and/or Fe₂O₃, from about 0.5 wt % to about to about 30 wt % of MnO, from about 2 wt % to about 30 wt % of CaO, from about 1 wt % to about 30 wt % of Na₂O, from about 0 wt % to about 25 wt % of K₂O, from about 0 wt % to about 5 wt % of TiO₂, less than about 2 wt % of MnO, and less than about 2 wt % of P₂O₅. In another embodiment of the invention, the natural mineral may comprise less than about 60 wt % of SiO₂, from 10 wt % to about 20 wt % AlO, from about 2 wt % to about 20 wt % FeO and/or Fe₂O₃, from about 1 wt % to about to about 15 wt % of MnO, from about 5 wt % to about 15 wt % of CaO, from about 2 wt % to about 15 wt % of Na₂O, from about 0 wt % to about 12 wt % of K₂O, from about 0 wt % to about 3 wt % of TiO₂, less than about 1 wt % of MnO, and less than about 1 wt % of P₂O₅.

A smoke suppressant that may additionally function as a flame retardant comprises a nanohybrid where the core consists of an organic/inorganic halogenated, non-halogenated, and/or organophosphorus flame retardant material that are further surface modified with nanoparticles of metals or metal oxides (e.g., copper and/or copper oxides). Without intending to be bound by theory, the heat flux concentrating effect of the metal and metal oxides yields a temperature-responsive mechanism for thermal dissociation of flame retardant materials for rapid and effective flame retardant activity either via gas phase reactions, solid phase carbonaceous char formation and/or quenching/cooling effects. The suppression of flammable gas and smoke during combustion by these metal-based smoke suppressant is caused by: 1) consumption of oxygen by the metals to rapidly transform to the oxides of the metals through thermal oxidation at high temperatures and 2) oxidizing flammable carbon monoxide to non-flammable carbon dioxide from oxygen supplied by the metal oxides. Enhanced heat sink behavior is contributed by the high thermal conductivity or heat transfer capability of nano structured metals (or its compounds)-modified nanohybrid material and their polymer-matrix composites (e.g., metal-Graphene/Polypropylene or Polyamide).

Non-halogenated flame retardants that may be used in the core or the coating of the referenced smoke suppressants include but are not limited to: ammonium polyphosphate, aluminum trihydroxide, magnesium (di) hydroxide, melamine polyphosphate, zinc molybdate, calcium zinc molybdate, zinc oxide/phosphate complexes, zinc carbonates, zinc borates, antimony trioxides, tin oxides, iron oxides, zeolites, glass fibers, melamine, melamine cyanurate, melamine homologues, carbon-based materials (graphite/expandable graphite), graphene/graphene oxide, carbon nanotubes and inorganic materials, like gypsum, calcium carbonate, silicon dioxide, silicon carbide, and aluminum silicates (e.g., clays, FINTs, etc.).

Halogenated flame retardants that may be used in the core or the coating of the referenced smoke suppressants include any organo-halogen flame retardants that contain chlorine or bromine, or iodine or fluorine bonded to carbon.

Organophosphorus flame retardants that may be used in the core or the coating of the referenced smoke suppressants include organophosphates, organophosphonates, organophosphines, organophosphine oxides, and organophosphites.

In an embodiment of the invention, the nanohybrid metal and metal oxide nanoparticle coated core of organic/inorganic halogenated, non-halogenated, and/or organophosphorus flame retardant material comprises from about 0.001 wt % to about 10 wt %, from about 0.005 wt % to about 5 wt %, from about 0.01 wt % to about 4 wt %, or from about 0.1 wt % to about 2 wt % of the metal and metal oxide nanoparticle coating.

According to an embodiment of the invention, the polymer resin, or in the case of a partially polymerized polymer resin, comprises a smoke suppressant having a fire retardant core, a nanohybrid, and any combination thereof having a concentration of from about 1 wt % to about 40 wt %, from about 5 wt % to about 35 wt %, from about 10 wt % to about 30 wt %, or from about 20 wt % to about 30 wt %.

In yet another aspect, the invention provides a polymer resin, or in the case of a partially polymerized polymer resin, having a combination of a flame retardant and a smoke suppressant. In an embodiment of the invention, the flame retardant and the smoke suppressant include any one or combination of the flame retardants and any one or combination of the smoke suppressants, respectively disclosed herein. In certain embodiments of the invention, the flame retardant and/or the smoke suppressant may comprise any one or any combination of the compounds disclosed herein having the ability to both provide a frame retardance and a smoke suppressance. In certain embodiments of the invention, the polymer resin of the invention provides a finished polymer having at least a UL-94 V-0 fire retardant rating.

In an embodiment of the invention, an additive or as additionally referred to herein, an “enhancement additive” may be included in the polymer resin or a partially polymerized polymer resin to enhance the flame retardancy and smoke suppressance of the finished polymer. Further pursuant to this embodiment of the invention, the enhancement additive may comprise any one of or any combination of nanocomposites of clay and other inorganics such as ZnO, TiO2, and nitrogen phosphorus based fire retardants. In some embodiments, the additives can be in the form of nano-sized particles. Other examples include insulative or semi-conductive Buckminster fullerenes and doped fullerenes of the C₆₀ family, nanotubes of the same and the like, which offer unique properties that provide the necessary reduction in flame retardance and smoke suppression.

Still further pursuant to this embodiment of the invention, the concentration of the additive in the polymer resin composition is from about 0.05 wt % to about 5 wt %, from about 0.1 wt % to about 4 wt %, from 0.25 wt % to about 3 wt %, or from about 0.5 wt % to about 2 wt %.

In still another aspect of the invention, a method of manufacturing a polymer resin or a partially polymerized polymer resin that includes any of a flame retardant, a smoke suppressant, or a combination thereof is provided. The method of manufacturing such polymer resin includes the step of providing a mixture of the associated monomers, polymers, and copolymers of the polymer resin and adding any one or combination of an antioxidant, a stabilizer, a flame retardant, a smoke suppressant, and an additive to the mixture.

In an embodiment of the invention, the monomer, polymer, and copolymer are partially polymerized before any one or combination of the antioxidant, the stabilizer, the flame retardant, the smoke suppressant, and the additive is included in the mixture. In certain embodiments of the method for manufacturing the polymer resin or the partially polymerized polymer resins includes the step of reacting the mixture either through a thermosetting process, a thermoplastic process, and any combination thereof.

### EXAMPLES

The following Examples provide illustrative embodiments. In light of the present disclosure and the general level of skill in the art, those of ordinary skill in the art will appreciate that the following Examples are intended to be exemplary only and that numerous changes, modifications, and alterations can be employed without departing from the scope of the presently disclosed subject matter.

Several polymer resins in accordance with the presently disclosed subject matter and comparatives are identified herein below in Tables 1 and 3 and the fire retardant and smoke suppressant ratings respectively included in Tables 2 and 4.

The compounding of the samples identified in Tables 1 and 3 was carried out in a standard, counter-rotating twin-screw extruder. The starting material was introduced into the extruder in the indicated concentrations through a funnel. Compounding was continuous with the screws being operated at 100 rpm and the temperature being maintained at or below approximately 450° F. (232° C.). The polypropylene was extruded through a two-hole die into a water bath, then air-dried and chopped into pellets about ⅛ in. long and 3/16 in. in diameter.

### Example 1

Samples 1-8 in Table 1 are exemplary polypropylene resins that include certain antioxidants and stabilizers (hindered phenolic and phosphate ester), a non-drip agent (polytetrafluorethylene), a char promoter (pentaerythritol), and various polyphosphate-based flame retardants.

Sample 1 is a control sample that includes the antioxidant and stabilizer used in the samples of the example having FLAMEOFF® 100 as the fire retardant. Samples 2-4 each have 6 wt % of melamine polyphosphate and 6 wt % of pentaerythritol with 18 wt % of crystallized ammonium polyphosphate, ammonium polyphosphate having about 31 wt % of phosphorus and 14 wt % of nitrogen, and a melamine coated (about 5 wt % to about 15 wt %) ammonium polyphosphate, respectively.

Samples 5-8 includes varying concentrations of a fine/crystal blend of ammonium polyphosphate having about 18 wt % to 21 wt % phosphorus and about 21 wt % to 23 wt % nitrogen as the flame retardant. Various concentrations and components of the polypropylene polymers used in the polymer resin are included in Samples 5-8 as well.

As shown in this example, the flame retardant may be an ammonium polyphosphate based flame retardant having ammonium polyphosphate, melamine polyphosphate, and pentaerythritol. The polymer composition may comprise from about 10 wt % to about 40 wt % of the ammonium polyphosphate based flame retardant, in preferred embodiments of the invention.

In preferred embodiments of the invention, the ammonium polyphosphate based flame retardant may have from about 50 wt % to about 70 wt % ammonium polyphosphate, from about 15 wt % to about 25 wt % melamine polyphosphate, and from about 15 to about 25 wt %

TABLE 1
Sample Formulations (wt %)

| | Sample Number | | | | | | | |
|---|---|---|---|---|---|---|---|---|
| | 1 | 2 | 3 | 4 | 5 | 6 | 7 | 8 |
| Resins | | | | | | | | |
| Polypropylene Homopolymer | — | — | — | — | 44.80 | — | — | — |
| 40 g/10 m MF | | | | | | | | |
| Polypropylene | 59.85 | 59.80 | 59.80 | 59.80 | 10.00 | 59.80 | 49.80 | 39.80 |
| ~1% MA | | | | | | | | |
| 110-150 MFR | | | | | | | | |
| Maleated Polypropylene | — | — | — | — | 5.00 | — | — | — |
| Glass-Reinforced (20%) | 10.00 | 10.00 | 10.00 | 10.00 | 10.00 | 10.00 | 10.00 | 10.00 |
| Polypropylene | | | | | | | | |
| 3.00 MFR | | | | | | | | |
| Antioxidants & Stabilizers | | | | | | | | |
| Phenolic Antioxidant | 0.05 | 0.05 | 0.05 | 0.05 | 0.05 | 0.05 | 0.05 | 0.05 |
| High MW, hindered | | | | | | | | |
| Phosphate Ester | 0.10 | 0.10 | 0.10 | 0.10 | 0.10 | 0.10 | 0.10 | 0.10 |
| Polytetrafluoroethylene | — | 0.05 | 0.05 | 0.05 | 0.05 | 0.05 | 0.05 | 0.05 |
| MP 1000 | | | | | | | | |
| Flame Retardants | | | | | | | | |
| Ammonium Polyphosphate | — | 18.00 | — | — | — | — | — | — |
| Crystallized | | | | | | | | |
| Ammonium Polyphosphate | — | — | 18.00 | — | — | — | — | — |
| 31% P, 14% N | | | | | | | | |
| Ammonium Polyphosphate | — | — | — | 18.00 | — | — | — | — |
| Melamine coated (5-15 wt %) | | | | | | | | |
| Ammonium Polyphosphate | — | — | — | — | 30.00 | 30.00 | 40.00 | 50.00 |
| fine/crystal blend | | | | | | | | |
| 18-21 wt % P, 21-23 wt % N | | | | | | | | |
| 15-25 wt % Pentaerythritol | | | | | | | | |
| Melamine Polyphosphate | — | 6.00 | 6.00 | 6.00 | — | — | — | — |
| Pentaerythritol | — | 6.00 | 6.00 | 6.00 | — | — | — | — |
| Smoke Suppressants | | | | | | | | |
| Zirconium (IV) Hydrogen | — | — | — | — | — | — | — | — |
| Phosphate | | | | | | | | |
| Natural Mineral | — | — | — | — | — | — | — | — |
| Stearic Acid coated | | | | | | | | |
| Flame Retardant Mixture | | | | | | | | |
| FLAMEOFF ® 100 | 30.00 | — | — | — | — | — | — | — |

pentaerythritol, wherein the ammonium polyphosphate based flame retardant having a concentration of from about 10 wt % to about 40 wt % in the polymer resin composition;

Samples 1-8 were tested using the 94 UL plastics flammability test shown in FIG. 1. The results of these tests are included in Table 2A.

TABLE 2A
Strand Fire Retardant Test Results

| Sample | Flame | Smoke | Drip | |
|---|---|---|---|---|
| Number | Rating | Rating | Rating | Sag |
| 1 | 4 star | 4 star | No Drip | No Sag |
| 2 | 4 star | 4 star | No Drip | No Sag |
| 3 | 4 star | 4 star | Tiny Drip¹ | No Sag |
| 4 | 4 star | 4 star | No Drip | No Sag |
| 5 | 4 star | 4 star | Tiny Drip¹ | No Sag |
| 6 | 4 star | 4 star | Tiny Drip¹ | No Sag |
| 7 | 4 star | 4 star | No Drip | No Sag |
| 8 | 4 star | 4 star | No Drip | No Sag |

¹cotton ball (~6″ below) did not catch fire

Sample number 1, which is the control sample that includes the use of FLAMEOFF® 100 as a commercially available flame retardant mixture, is intended to show the performance of conventional mixtures readily available in the art. One of the motivations for undertaking this

TABLE 2B
Molded Cut Bar (2 mm) Fire Retardant Test Results

| Sample | Flame | Smoke | Drip | Color of | |
|---|---|---|---|---|---|
| Number | Rating¹ | Rating² | Rating³ | Smoke | Cotton Ball |
| 1 | 3 | 2 | 1 | White | Caught fire |
| 2 | 3 | 2 | 1 | White | Caught fire |
| 3 | 3 | 2 | 1 | White | Caught fire |
| 4 | 3 | 2 | 1 | White | Caught fire |
| 5 | 4 | 2 | 2 | White | Drip but no ignition |
| 6 | 3 | 2 | 1 | White/Grey | Caught fire |
| 7 | 3 | 2 | 1 | White | Caught fire |
| 8 | 4 | 3 | 2 | White | Drip but no ignition |

¹Scale of 1 to 4: 1 = non-stop burning, 4 = truly fireproof
²Scale of 1 to 4: 1 = excessive smoke, 4 = minimal smoke
³Scale of 1 to 4: 1 = total drip, 4 = non-drip

work that has led to the inventive subject-matter is to identify compositions that improve the smoke suppression and flame retardant capabilities that are provided in the conventionally available compositions.

Samples 1-8 were additionally tested for fire retardancy using a 2 mm molded cut bar with the results shown in Table 2B.

As the results of the tests in this example indicate, the samples that do not include the prior art known composition for flame retardancy provided a good flame rating and a good smoke rating. Samples 3, 5 and 6 experienced a small drip, but this did not cause the dry cotton to catch fire.

### Example 2

Samples 9-16 in Table 3 are exemplary polypropylene resins that include certain antioxidants and stabilizers (hindered phenolic and phosphate ester), the fine/crystal blend of ammonium polyphosphate having about 18 wt % to 21 wt % phosphorus and about 21 wt % to 23 wt % nitrogen as the flame retardant in certain samples, and either the zirconium (IV) hydrogen phosphate or the stearic acid coated natural mineral as the smoke suppressant.

TABLE 3
Sample Formulations (wt %)

| | Sample Number | | | | | | | |
|---|---|---|---|---|---|---|---|---|
| | 9 | 10 | 11 | 12 | 13 | 14 | 15 | 16 |
| Resins | | | | | | | | |
| Polypropylene Homopolymer | — | — | — | — | — | — | — | 60.00 |
| 40 g/10 m MF | | | | | | | | |
| Polypropylene | 57.85 | 64.80 | 62.80 | 79.80 | 69.80 | 59.80 | 74.80 | 10.00 |
| ~1% MA | | | | | | | | |
| 110-150 MFR | | | | | | | | |
| Maleated Polypropylene | — | — | — | — | — | — | — | 4.80 |
| Glass-Reinforced (20%) | 10.00 | 10.00 | 10.00 | — | — | — | — | — |
| Polypropylene | | | | | | | | |
| 3.00 MFR | | | | | | | | |
| Antioxidants & Stabilizers | | | | | | | | |
| Phenolic Antioxidant | 0.05 | 0.05 | 0.05 | 0.05 | 0.05 | 0.05 | 0.05 | 0.05 |
| High MW, hindered | | | | | | | | |
| Phosphate Ester | 0.10 | 0.10 | 0.10 | 0.10 | 0.10 | 0.10 | 0.10 | 0.10 |
| Polytetrafluoroethylene | — | 0.05 | 0.05 | 0.05 | 0.05 | 0.05 | 0.05 | 0.05 |
| MP 1000 | | | | | | | | |
| Flame Retardants | | | | | | | | |
| Ammonium Polyphosphate | — | — | — | — | — | — | — | — |
| Crystallized | | | | | | | | |
| Ammonium Polyphosphate | — | — | — | — | — | — | — | — |
| 31% P, 14% N | | | | | | | | |
| Ammonium Polyphosphate | — | — | — | — | — | — | — | — |
| Melamine coated (5-15 wt %) | | | | | | | | |
| Ammonium Polyphosphate | 30.00 | 25.00 | 25.00 | — | — | — | 15.00 | 15.00 |
| fine/crystal blend | | | | | | | | |
| 18-21% P, 21-23% N | | | | | | | | |
| 15-25 wt % Melamine | | | | | | | | |
| Melamine Polyphosphate | — | — | — | — | — | — | — | — |
| Pentaerythritol | — | — | — | — | — | — | — | — |
| Smoke Suppressants | | | | | | | | |
| Zirconium (IV) Hydrogen | 2.00 | — | 2.00 | — | — | — | — | — |
| Phosphate | | | | | | | | |
| Natural Mineral | — | — | — | 20.00 | 30.00 | 40.00 | 10.00 | 10.00 |
| Stearic Acid coated | | | | | | | | |
| Flame Retardant Mixture | | | | | | | | |
| FLAMEOFF ® 100 | — | — | — | — | — | — | — | — |

Samples 9-16 were tested using the 94 UL plastics flammability test shown in FIG. 1. The results of these tests are included in Table 4.

TABLE 4
Strand Fire Retardant Test Results

| Sample | Flame | Smoke | Drip | |
|---|---|---|---|---|
| Number | Rating | Rating | Rating | Sag |
| 1 | 4 star | 4 star | No Drip | No Sag |
| 9 | 4 star | 4 star | No Drip | No Sag |
| 10 | 4 star | 4 star | No Drip | No Sag |
| 11 | 4 star | 4 star | No Drip | No Sag |
| 12 | — | 4 star | Drip¹ | Sag² |
| 13 | — | 2 star | Drip¹ | Sag² |
| 14 | — | 2 star | Drip | Sag² |
| 15 | — | 2 star | Drip | Sag² |
| 16 | 1 star | 2 star | Drip | Sag² |

¹Cotton ball (~6″ below) did not catch fire.
²No char formation.

Samples 9-11 of this example had a good flame rating and a good smoke rating. The remaining samples experienced poor ratings. Apparently, the stearic acid coated natural mineral did not perform as well in these samples as a smoke suppressant.

Without intending to be bound by theory, more recent testing using the nanohybrid flame retardant having core consists of an organic/inorganic halogenated, non-halogenated, and/or organophosphorus flame retardant material that has been surface modified with nanoparticles of metals or metal oxides has shown to provide a better flame retardancy and smoke suppressance. Additionally, the fire retardants having a smaller diameter core that comprises a metal in combination with a metal hydrate uniformly overcoated with an organic and/or inorganic flame retardant materials have also shown to provide an improved flame retardancy and smoke suppressance over that demonstrated in Samples 12-16 as well. Thus, this testing appears to demonstrate that the nonhybrid and the uniformly overcoated small diameter fire retardant core flame retardants appear to be the preferred smoke suppressant.

### Example 3

Sample numbers 17-20 in Table 5 are exemplary polypropylene resins that are constructed to include certain antioxidants and stabilizers (hindered phenolic and phosphate ester); a blend of from about 50 wt % to about 70 wt % ammonium polyphosphate, from about 15 wt % to about 25 wt % melamine, and from about 15 wt % to about 25 wt % of a three-component fire retardant blend; zirconium (IV) hydrogen phosphates as the smoke suppressant; and the FLAMEOFF® 100 flame retardant mixture. The use of the latter compound was more for the purposes of identifying the capability that may be provided by conventionally available flame retardant compounds.

TABLE 5
Polypropylene-Based Sample Formulations (wt %)

| | Sample Number | | | |
|---|---|---|---|---|
| | 17 | 18 | 19 | 20 |
| Resin Systems | | | | |
| Polypropylene Homopolymer 3.5 g/10 m MF | — | 44.80 | — | 42.80 |
| Polypropylene Homopolymer 0.5 g/10 m MF | — | — | 44.80 | — |
| Maleated Polypropylene ~1% MA, | 59.85 | 10.00 | 10.00 | 10.00 |
| Compatibilizer-1 | | | | |
| Maleated Polypropylene <1% MA, | — | 5.00 | 5.00 | 5.00 |
| Compatibilizer-2 | | | | |
| Glass Fiber Reinforced (20% GF) | 10.00 | 10.00 | 10.00 | 10.00 |
| Polypropylene Homopolymer 3.0 MFR | | | | |
| Antioxidants & Stabilizers | | | | |
| Hindered Phenolic Antioxidant | 0.05 | 0.05 | 0.05 | 0.05 |
| High MW Phosphate Ester Process Stabilizer | 0.10 | 0.10 | 0.10 | 0.10 |
| Polytetrafluoroethylene Process Aid | — | 0.05 | 0.05 | 0.05 |
| Flame Retardants | | | | |
| Ammonium Polyphosphate, 50-70 wt % | — | 30.00 | 30.00 | 30.00 |
| Melamine, 15-25 wt % | | | | |
| 3-component blend, 15-25 wt % | | | | |
| Smoke Suppressants | | | | |
| Zirconium (IV) Hydrogen Phosphate | — | — | — | 2.00 |
| Flame Retardant Mixture | | | | |
| FLAMEOFF ® 100 | 30.00 | — | — | — |

The ammonium phosphate melamine blend includes compounds that provide an effective non-halogenated formulated intumescent blend based on a fine particle crystal phase having a

TABLE 6A
Molded Cut Bar Fire Retardant Test Results

| | Sample Number | | | |
|---|---|---|---|---|
| | 17 | 18 | 19 | 20 |
| Flame Characteristics | | | | |
| 1 = non-stop burning to 4 = truly fire proof | 3 | 4 | 4 | 4 |
| Dripping Characteristics | | | | |
| 1 = total drip and cotton ball catches fire | 4 | 4 | 4 | 4 |
| to 4 = non-drip | | | | |
| Smoke Evaluation | | | | |
| 1 = excessive smoke to 4 = minimal smoke | 2 | 3 | 3 | 3 |
| Type of Smoke (color) | white | white | white | white |

particle size of about 10 to 12 microns. The components that may be included in this flame retardant formulation are any of those compounds further described herein as flame retardant compounds.

Sample numbers 17-20 have been tested using the 94 UL plastics flammability test shown in FIG. 1. The results of these tests are included in Table 6A.

The comments and observations included in Table 6B have been made concerning the results of the tests for sample numbers 16 to 20.

TABLE 6B
Comparative Flame Ratings of Molded Cut Bars

| Sample | |
|---|---|
| Number | Additional Notes (Comments/Observations) |
| 17 | No flaming drip, but entire sample became pliable enough to |
| | fall. Self extinguished. |
| 18 | No drip and self-extinguished. |
| 19 | No drip and self-extinguished. |
| 20 | No drip and self-extinguished. |

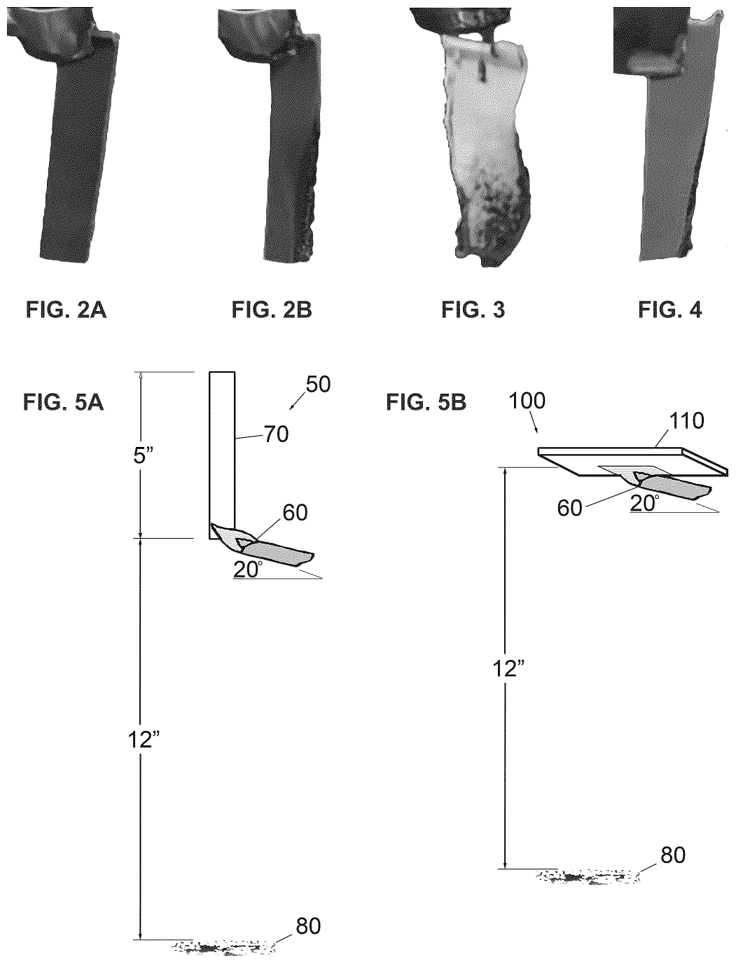

FIGS. 2A-2B illustrate the test sequence images of the plastics flammability test for sample No. 20. FIG. 2A shows the test bar subjected to testing and FIG. 2B illustrates the resilience of sample number 20 following being subjected to testing.

### Example 4

Sample numbers 21-22 in Table 7 are exemplary polyethylene resins that include certain antioxidants and stabilizers (hindered phenolic and phosphate ester); similar to that used in the polypropylene-based samples of Example 3, a blend of from about 50 wt % to about 70 wt % ammonium polyphosphate, from about 15 wt % to about 25 wt % melamine, and from about 15 wt % to about 25 wt % of a three-component fire retardant blend; zinc borate as the smoke suppressant; and the FLAMEOFF® 100 flame retardant mixture.

As disclosed earlier, the ammonium phosphate melamine blend includes compounds that provide an effective non-halogenated formulated intumescent blend based on a fine particle crystal phase having a particle size of about 10 to 12 microns. The components that may be included in this flame retardant formulation are any of those compounds further described herein as flame retardant compounds.

TABLE 7
Polyethylene-Based Sample Formulations (wt %)

Sample Number

| | 21 | 22 |
|---|---|---|
| Resin Systems | | |
| High Density Polyethylene | 52.80 | 45.80 |
| 90-140° C. MI | | |
| RotoMolding Grade | | |
| Maleated Polyethylene | 10.00 | 12.00 |
| 1.2 g/10 min MF, ~1% MA | | |
| Compatibilizer-3 | | |
| Glass Fiber Master Batch (20% GF) | — | 5.00 |
| Polypropylene Homopolymer 3.0 MFR | | |
| Antioxidants & Stabilizers | | |
| Hindered Phenolic Antioxidant | 0.05 | 0.05 |
| High MW Phosphate Ester Process Stabilizer | 0.10 | 0.10 |
| Polytetrafluoroethylene Process Aid | 0.05 | 0.05 |
| Flame Retardants | | |
| Ammonium Polyphosphate, 50-70 wt % | 21.00 | 21.00 |
| Melamine, 15-25 wt % | | |
| 3-component blend, 15-25 wt % | | |
| Melamine Polyphosphate | 7.00 | 7.00 |
| Pentaerythritol | 7.00 | 7.00 |
| Smoke Suppressants | | |
| Zinc Borate | 2.00 | 2.00 |

Sample numbers 21-22 have been tested using the 94 UL plastics flammability test shown in FIG. 1. The results of these tests are included in Table 8A.

The comments and observations included in Table 8B have been made concerning the results of the tests for sample numbers 21 and 22.

FIG. 3 and FIG. 4 respectively show sample images following a UL94 plastics flammability test for sample numbers 21 and 22. Sample number 22 has a relatively small amount of glass fiber modifier without affecting the other properties of the material as shown in sample number 21 that has not glass fiber reinforcement. The form and concentration of the glass fiber modifier is such that it enhances the flame retardancy of the polymer composition and increases the stability of same.

TABLE 8A
Molded Cut Bar Retardant Test Results

Sample Number

| | 21 | 21 |
|---|---|---|
| Flame Characteristics | | |
| 1 = non-stop burning to 4 = truly fire proof | 4 | 4 |
| Dripping Characteristics | | |
| 1 = total drip and cotton ball catches fire | 4 | 4 |
| to 4 = non-drip | | |
| Smoke Evaluation | | |
| 1 = excessive smoke to 4 = minimal smoke | 3 | 3 |
| Type of Smoke (color) | white | white |

TABLE 8B
Comparative Flame Ratings of Molded Cut Bars

| Sample | |
|---|---|
| Number | Additional Notes (Comments/Observations) |
| 21 | No flaming drip, but entire sample became pliable enough to |
| | fall. Self extinguished. |
| 22 | No drip and self-extinguished. |

### Example 5

Sample numbers 23-27 in Table 9 are exemplary polypropylene resins. Sample number 23 is the control sample while sample numbers 24-27 are constructed to include certain antioxidants and stabilizers (hindered phenolics, high molecular weight phosphate ester, and petrafluoroethylene); flame retardants including a blend of from about 21 wt % to about 25 wt % of a blended ammonium polyphosphate melamine composition, from about 7 wt % to about 9 wt % melamine polyphosphate, and from about 0.05 wt % of polytetrafluorethylene; about 2 wt % of a zinc borate smoke suppressant; and about 2 wt % to about 20 wt % of about 1/16″ chopped fibers.

TABLE 9
Polypropylene-Based Sample Formulations (wt %)

| | Sample Number | | | | |
|---|---|---|---|---|---|
| | 23 | 24 | 25 | 26 | 27 |
| Resin Systems | | | | | |
| Polypropylene Homoplymer 3.5 | 100.00 | 40.00 | 34.00 | 21.40 | 18.10 |
| g/10 m MF | | | | | |
| Polypropylene Homoplymer 0.5 | — | 5.80 | 3.30 | 12.00 | 8.70 |
| g/10 m MF | | | | | |
| Maleated Polypropylene <1% MA | — | 10.00 | 10.00 | 10.00 | 10.00 |
| (Compatibilizer-1) | | | | | |
| Maleated Polypropylene >1% MA | — | 5.00 | 5.00 | 5.00 | 5.00 |
| (Compatibilizer-2) | | | | | |
| Antioxidants & Stabilizers | | | | | |
| Hindered Phenolic Antioxidant - 1 | — | 0.05 | 0.05 | — | — |
| Hindered Phenolic Antioxidant - 2 | — | — | — | 0.05 | 0.05 |
| High MW Phosphate Ester Process | — | 0.10 | 0.10 | 0.14 | 0.10 |
| Stabilizer | | | | | |
| Polytetrafluoroethylene Process | — | 0.05 | 0.05 | 0.05 | 0.05 |
| Aid | | | | | |
| Flame Retardants | | | | | |
| Ammonium Polyphosphate, | — | 21.00 | 25.00 | 23.00 | 21.00 |
| 50-70 wt % | | | | | |
| Melamine, 15-25 wt % | | | | | |
| 3-component blend, 15-25 wt % | | | | | |
| Melamine Polyphosphate | — | 7.00 | 9.00 | 8.20 | 7.50 |
| Pentaerythritol | — | 7.00 | 9.00 | 8.20 | 7.50 |
| Smoke Suppressants | | | | | |
| Zinc Borate | — | 2.00 | 2.00 | 2.00 | 2.00 |
| Inorganic Fibers | | | | | |
| Chopped Fibers ( 1/16″) | — | 2.00 | 2.50 | 10.00 | 20.00 |

Sample numbers 23-27 have been subjected to certain mechanical and impact property tests including tensile elongation at break, tensile strength, and tensile modulus according to ASTM standard D638 (2014); flexural strength, tangent modulus, and secant modulus according to ASTM standard D790 (2017); and notched izod impact test according to ASTM standard D256 as shown in Table 10.

TABLE 10
Mechanical and Impact Property Tests

| | ASTM | | Sample | | | | |
|---|---|---|---|---|---|---|---|
| Property | Standard | Units | 23 | 24 | 25 | 26 | 27 |
| Tensile | D638 (2014) | % | 34.9 | 8.5 | 3.6 | 2.6 | 1.8 |
| Elongation at | | | | | | | |
| Break | | | | | | | |
| Tensile Strength | | psi | 5,380 | 4,720 | 4,710 | 7,130 | 8,500 |
| Tensile Modulus | | psi | 305,000 | 400,000 | 582,000 | 820,000 | 1,120,000 |
| Flexural Strength | D790 (2017) | psi | 7,630 | 8,400 | 8,600 | 12,000 | NM |
| Tangent Modulus | | psi | 283,000 | 339,000 | 445,000 | 649,000 | NM |
| Secant Modulus | | psi | 260,000 | 325,000 | 406,000 | 604,000 | NM |
| Notched Izod | D256 | ft-lbs/inch | 0.70 | 0.74 | 0.61 | 1.00 | NM |
| Impact (RT) | | | | | | | |

The results of the UL 94 VO tests performed on sample numbers 23 to 27 are included in Table 11.

TABLE 11
Comparative Flame Ratings
(UL94 VO Test Standard)

| | | Sample | | | | |
|---|---|---|---|---|---|---|
| Test Property | Criteria | 23 | 24 | 25 | 26 | 27 |
| After Flame + After | ≤30 seconds | >30 secs | 13.8 | 9.2 | 8.6 | 15.1 |
| Glow Time | | | | | | |
| Dripping | Yes or No | Yes | No | No | No | No |
| Characteristics | | | | | | |
| Ignite Cotton by | Yes or No | Yes | No | No | No | No |
| Falling Flame | | | | | | |
| Particles | | | | | | |
| Flame Rating | VO (Pass) or | Burn (Fail) | VO (Pass) | VO (Pass) | VO (Pass) | VO (Pass) |
| Reported (per UL94 | Burn (Fail) | | | | | |
| Vertical Burn) | | | | | | |

The 5V vertical flame tests are performed on both bar and plaque samples as shown in FIGS. 5A and 5B, respectively. FIG. 5A is a view of the vertical flame test that is performed on a bar sample. The vertical flame test 50 includes a bar specimen 70 that is supported is supported in a vertical position and a flame 60 is applied to the bar specimen 70 for five (“5”) seconds followed by a five (“5”) second removal. This procedure is repeated four (“4”) additional times.

FIG. 5B is a view of the vertical flame test that is performed on a plaque sample. The vertical flame test 100 includes a plaque specimen 110 and undergoes the same procedure as for the bar specimen 70 with the exception that the plaque specimen 110 is mounted horizontally, and the flame 60 is applied to the center of the lower surface of the plaque specimen 110. The pass/fail criteria for 5VA and 5VB vertical testing standard are included in Table 12. Each of the vertical flame tests 50, 100 includes cotton 80 at the base of the vertical flame test apparatus to test whether dripping particles ignite the cotton 80.

TABLE 12
Pass/Fail Criteria for UL 94 Vertical Testing Standard

| Vertical Rating | Requirements |
|---|---|
| 5VA | Specimens must have any flaming or glowing |
| | combustion for more than 60 seconds after the five |
| | flame applications. |
| | Specimens must not drip flaming particles that ignite |
| | the cotton. |
| | Plaque specimens must not exhibit burn through (a |
| | hole develops). |
| 5VB | Specimens must not have any flaming or glowing |
| | combustion for more than 60 seconds after the five |
| | flame applications. |
| | Specimens must not drip flaming particles that ignite |
| | the cotton. |
| | Plaque specimens may exhibit burn through (a hole |
| | develops). |

The comparative flame ratings for sample numbers 24 to 27 are provided in Table 13.

TABLE 13
Comparative Flame Ratings Sample Preparation: injection
molded, 3.0 mm thick plaque, conditioned at 50%
RH for 48 hours (UL94 5V Test Standard)

| | | Sample | | | |
|---|---|---|---|---|---|
| Property | Criteria | 24 | 25 | 26 | 27 |
| After Flame Time | 60 seconds | 16.2 | 15.0 | 15.8 | 16.1 |
| Time until Smoke Dissipates | Seconds | 0.0 | 0.0 | 0.6 | 0.2 |
| Burn Through | Yes or No | No | No | No | No |
| Flame Rating Reported | 5VA (Best)/ | 5VA | 5VA | 5VA | 5VA |
| | 5VB (Good) | | | | |

Sample numbers 23 to 27 were subjected to a “Max-Out” burn test as further explained below. The results of this test are included in Table 14.

TABLE 14
Comparative Flame Ratings
UL94 5 V “Max-Out” Simulated Burn Test*

| | Unit | | | | | |
|---|---|---|---|---|---|---|
| Test Property | Measurement | 23 | 24 | 25 | 26 | 27 |
| Time Burned Continuously | seconds | Flammable | 66.8 | 90.0 | 90.0 | 90.0 |
| (90 sec max) | | (testing not | | | | |
| After-Burn Time | seconds | continued) | 3.9 | 5.4 | 7.2 | 12.9 |
| Time Until Smoke | seconds | | 58.0 | 58.0 | 74.0 | 49.0 |
| Dissipation | | | | | | |
| Burn Through | seconds | | Yes (hole | No | No | No |
| | | | formed) | | | |
| Assigned Flame Rating | Fire Proof > | | Flame | Fire | Fire | Fire |
| | Flame Retardant | | Retardant | Proof | Proof | Proof |

*The “Max Out” burn test was devised to test the fire- or flame-proof characteristics of the samples under very harsh conditions. The flame is applied ‘continuously’ until burn through occurred or after 90 seconds had elapsed.

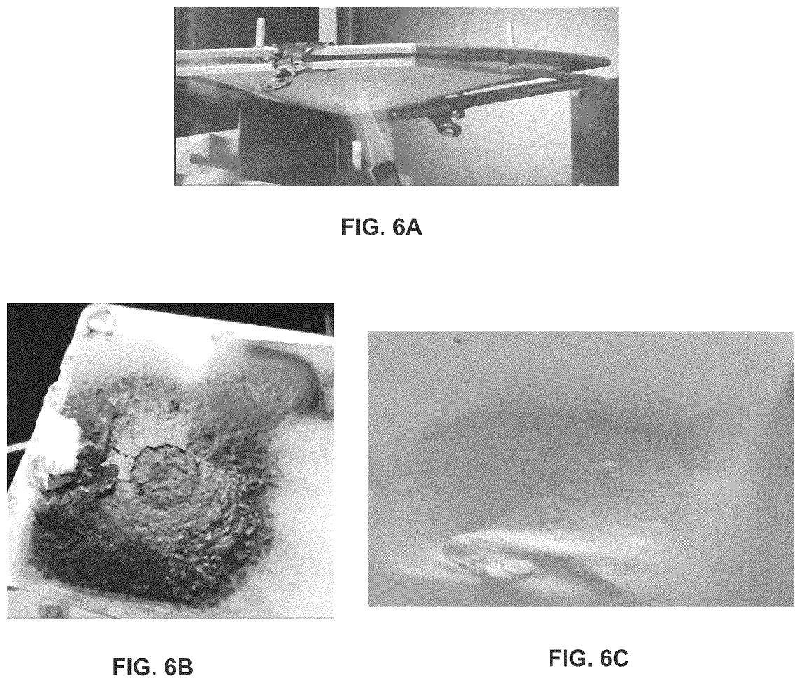

FIGS. 6A-6C show sequence-test images of a “Max-Out” burn test performed on sample number 26. FIG. 6A shows the plaque specimen for sample number 26 at the beginning of direct flame exposure in the “Max-Out” burn test. FIG. 6B shows the plaque specimen for sample number 26 following the 90 second continuous flame exposure. FIG. 6C shows the non-exposed side of the test specimen for sample number 26 following completion of the “Max-Out” burn test.

Having the benefit of the teachings presented in the descriptions herein, many modifications and other embodiments of the invention set forth herein will come to mind to one skilled in the art to which this invention pertains. It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the included claims.

That which is claimed:

1. A polymer resin composition comprising
a compatibilizing agent having a concentration of from about 5 wt % to about 85 wt %;
an ammonium polyphosphate based flame retardant having a concentration of from about 10 wt % to about 40 wt % in the polymer resin composition;
a non-drip agent having a concentration of from about 0.01 wt % to about 0.5 wt %; and
a glass fiber modifier having a concentration of from about 0.5 wt % to about 3 wt %.

2. The polymer resin composition of claim 1, wherein the compatibilizing agent comprising a maleated polymer compound.

3. The polymer resin composition of claim 1, wherein the ammonium polyphosphate based flame retardant having from about 50 wt % to about 70 wt % ammonium polyphosphate, from about 15 wt % to about 25 wt % melamine polyphosphate, and from about 15 to about 25 wt % pentaerythritol.

4. The polymer resin composition of claim 1, wherein the ammonium polyphosphate based flame retardant comprising at least one of a crystallized ammonium polyphosphate, an ammonium polyphosphate, a melamine coated ammonium polyphosphate, a fine/crystal blend of ammonium polyphosphate, and any combination thereof.

5. The polymer resin composition of claim 4, wherein the ammonium polyphosphate based flame retardant having from about 25 wt % to about 35 wt % phosphorus and from about 10 wt % to about 20 wt % nitrogen.

6. The polymer resin composition of claim 4, wherein the melamine coated ammonium polyphosphate having a concentration of from about 5 wt % to about 25 wt % melamine based upon the weight of the melamine coated ammonium polyphosphate.

7. The polymer resin composition of claim 4, wherein the fine/crystal blend of ammonium polyphosphate having from about 15 wt % to about 25 wt % phosphorus and from about 15 wt % to about 30 wt % nitrogen.

8. The polymer resin composition of claim 1, wherein the ammonium polyphosphate based based flame retardant comprising a blend having melamine and up to three other flame retardant compounds.

9. The polymer resin composition of claim 8, wherein the melamine of the ammonium polyphosphate flame retardant having a concentration of from about 15 wt % to about 25 wt %.

10. The polymer resin composition of claim 8, wherein the up to three other flame retardant compounds of the ammonium polyphosphate flame retardant having a concentration of from about 15 wt % to about 25 wt %.

11. The polymer resin composition of claim 8, wherein the up to three other flame retardant compounds comprising any one of or any combination of ammonium polyphosphate, melamine polyphosphate, and pentaerythritol.

12. The polymer resin composition of claim 8, wherein the ammonium polyphosphate based flame retardant having a particle diameter of from about 10 microns to about 12 microns.

13. The polymer resin composition of claim 1, additionally comprising a melamine polyphosphate having a concentration of from about 1 wt % to about 20 wt %.

14. The polymer resin composition of claim 1, additionally comprising a char promoter having a concentration of from about 1 wt % to about 20 wt %.

15. The polymer resin composition of claim 14, wherein the char promoter comprises a pentaerythritol.

16. The polymer resin composition of claim 1, additionally comprising a smoke suppressant.

17. The polymer resin composition of claim 16, wherein the smoke suppressant comprising a zinc (IV) hydrogen phosphate having a concentration of from about 0.5 wt % to about 5 wt %.

18. The polymer resin composition of claim 16, wherein the smoke suppressant comprising a fire retardant core having an overcoat including one of or any combination of organic/inorganic halogenated, non-halogenated, and organophosphorus flame retardant materials.

19. The polymer resin composition of claim 18, the fire retardant core having a diameter of from about 1 nm to about 500 nm.

20. The polymer resin composition of claim 18, where the fire retardant core comprising any one of or any combination of a metal and a metal hydrate of magnesium, calcium, aluminum, iron, zinc, barium, copper, and nickel.

21. The polymer resin composition of claim 18, wherein the organic/inorganic halogenated, non-halogenated, and organophosphorus flame retardant materials includes any one of or any combination of ammonium polyphosphate, aluminum trihydroxide, magnesium (di) hydroxide, melamine polyphosphate, zinc molybdate, calcium zinc molybdate, zinc oxide/phosphate complexes, zinc carbonates, zinc borates, antimony trioxides, tin oxides, iron oxides, zeolites, glass fibers, melamine, melamine cyanurate, melamine homologues, carbon-based materials (graphite/expandable graphite), graphene/graphene oxide, carbon nanotubes, gypsum, calcium carbonate, silicon dioxide, silicon carbide, aluminum silicates; chlorine or bromine, or iodine or fluorine bonded to carbon; and organophosphates, organophosphonates, organophosphines, organophosphine oxides, and organophosphites.

22. The polymer resin composition of claim 18, wherein the smoke suppressant having a concentration of from about 2 wt % to about 25 wt %.

23. The polymer resin composition of claim 16, wherein the smoke suppressant comprising a nanohybrid having a core that includes any one of or any combination of an organic/inorganic halogenated, non-halogenated, and/or organophosphorus flame retardant material the surface of the core modified with nanoparticles of any one of or any combination of a metal and a metal oxide.

24. The polymer resin composition of claim 23, wherein the metal and a metal oxide comprises any one of or any combination of magnesium, calcium, aluminum, iron, zinc, barium, copper, and nickel.

25. The polymer resin composition of claim 23, wherein the smoke suppressant having a concentration of from about 2 wt % to about 25 wt %.

26. The polymer resin composition of claim 16, wherein the smoke suppressant comprising a stearic acid coated natural mineral.

27. The polymer resin composition of claim 26, wherein the natural mineral includes SiO₂, AlO, FeO, Fe₂O₃, MgO, CaO, Na₂O, K₂O, TiO₂, MnO, Ph₂O₅, and any combination thereof.

28. The polymer resin composition of claim 1 additionally comprising an enhancement additive having a concentration of from about 0.05 wt % to about 5 wt %.

29. The polymer resin composition of claim 28, wherein the enhancement additive comprising any one of or any combination of a nano-composite of clay; and nano-sized particles including any one of or any combination of ZnO, TiO₂, and a nitrogen and phosphorus based fire retardants.
